(19) United States
(12) Patent Application Publication
(10) Pub. No.: US 2025/0309654 A1
(43) Pub. Date: Oct. 2, 2025

(54) UTILITY ASSET ONBOARDING

(71) Applicant: Inventus Holdings, LLC, Juno Beach, FL (US)

(72) Inventors: Jeroen C. Leverman, Fort Pierce, FL (US); Annamalai Lakshmanan, Stuart, FL (US); Melanie Andara, Juno Beach, FL (US)

(21) Appl. No.: 18/618,771

(22) Filed: Mar. 27, 2024

(51) Int. Cl. H02J 3/38; H02J 3/00; H02J 13/00

(52) U.S. Cl. CPC H02J 3/381; H02J 3/004; H02J 13/00002; H02J 2300/24; H02J 2300/28

(57) ABSTRACT

Onboarding a utility asset includes operations include receiving a standardized equipment power curve for an ego utility asset to be onboarded in a farm of utility assets. The standardized equipment power curve including a relation between a set of provided operational parameters and a corresponding array of expected power values generated by the ego utility asset. The operations also include customizing the equipment power curve based on the standardized power curve to generate a customized power curve. The operations further include calculating a calculated power value characterizing an actual amount of power generated by the ego utility asset based on a particular parameter. The operations yet further include predicting a predicted power value characterizing a predicted amount of power to be generated by the ego utility asset for the particular parameter based on the customized power curve. The operations include calculating a performance metric for the ego utility asset.

### TECHNICAL FIELD

This description relates to onboarding an ego utility asset to a group of utility assets by customizing a power curve of the ego utility asset based on a standardized power curve of other utility assets.

### BACKGROUND

Utility assets for generating electrical power using renewable resources (e.g., wind, solar, etc.) are sometimes grouped together to provide electricity to an electrical grid. For example, wind energy is sometimes used to generate electrical power using a wind turbine as a utility asset. A plurality of wind turbines are sometimes grouped together at power plants, often referred to as wind farms or wind parks. As another example, a solar panel is a utility asset that uses solar radiation to generate electrical power. Solar panels are sometimes grouped in solar arrays.

To function as a part of a group, such as the wind farm or solar array, new utility assets are added to the group in an onboarding process. During the onboarding process, the new utility asset undergoes testing and tuning to ensure that the utility asset is functioning properly as a member of the group.

### SUMMARY

In one example, operations include receiving a standardized equipment power curve for an ego utility asset to be onboarded in a farm of utility assets. The standardized equipment power curve including a relation between a set of provided operational parameters and a corresponding array of expected power values generated by the ego utility asset. The operations also include customizing the equipment power curve based on the standardized power curve to generate a customized power curve. The operations further include calculating a calculated power value characterizing an actual amount of power generated by the ego utility asset based on a particular parameter. The operations yet further include predicting a predicted power value characterizing a predicted amount of power to be generated by the ego utility asset for the particular parameter based on the customized power curve. The operations include calculating a performance metric for the ego utility asset. The performance metric characterizes a comparison of the calculated power value and the predicted power value.

Another example relates to an onboarding asset system that includes a memory for storing machine-readable instructions and a processor core. The processor core accesses the machine-readable instructions and executes the machine-readable instructions as operations. The operations include receiving an equipment power curve for an ego utility asset to be onboarded in a farm of utility assets. The equipment power curve includes a relation between a set of provided operational parameters and a corresponding array of expected power values generated by the ego utility asset. The operations also include normalizing the equipment power curve based on a standardized power curve to generate a customized power curve. The standardized power curve is based on a first power curve from a first source and a second power curve from a second source different than the first source. The operations further include calculating a calculated power value characterizing an actual amount of power generated by the ego utility asset based on a particular parameter. The operations yet further include predicting a predicted power value characterizing a predicted amount of power to be generated by the ego utility asset for the particular parameter based on the customized power curve. The operations include calculating a performance metric for the ego utility asset. The performance metric characterizes a comparison of the calculated power value and the predicted power value.

In yet another example, an asset onboarding method is provided. The method includes receiving an equipment power curve for an ego utility asset to be onboarded in a farm of utility assets. The equipment power curve includes a relation between a set of provided operational parameters and a corresponding array of expected power values generated by the ego utility asset. The method also includes normalizing the equipment power curve based on a standardized power curve to generate a customized power curve. The standardized power curve is based on a first power curve from a first source and a second power curve from a second source different than the first source. The method further includes calculating a calculated power value characterizing an actual amount of power generated by the ego utility asset based on a particular parameter. The method yet further includes predicting a predicted power value characterizing a predicted amount of power to be generated by the ego utility asset for the particular parameter based on the customized power curve. The method includes calculating a performance metric for the ego utility asset. The performance metric characterizes a comparison of the calculated power value and the predicted power value.

### BRIEF DESCRIPTION OF THE DRAWINGS

FIG. 1 illustrates a diagram of an example physical environment for a utility asset onboarding system.

FIG. 2 illustrates an example of an operating environment for a utility asset onboarding system.

FIG. 3 illustrates an example of energy data for a utility asset received by utility asset onboarding system.

FIG. 4A illustrates an example energy chart of a utility asset including actual energy, expected energy, and lost energy.

FIG. 4B illustrates the energy data corresponding to the example energy chart of FIG. 4A.

FIG. 5 illustrates a diagram of another example physical environment for a utility asset onboarding system.

FIG. 6 illustrates a flowchart of an example method for utility asset onboarding.

### DETAILED DESCRIPTION

The onboarding process of utility assets is manually intensive and time consuming. For example, utility assets are typically installed and brought online for an observational period. During this observational period, onboarding operations are executed to ensure that operational parameters are tuned, a maintenance schedule is selected, and energy data to comply with a purchase power agreement (PPA) is supplied. The long onboarding process may allow a utility asset to linger in a state of uncertainty and/or complicate compliance with the PPA.

This description is related to an onboarding application that curtails the time duration for the onboarding operations for an ego utility asset, such as a newly installed wind turbine or solar panel. An “ego utility asset,” as used herein, refers to a specific utility asset among, for example, a group of similarly situated utility assets. The “ego utility asset” may be any energy generation asset. In particular, the systems and methods of the description are described with respect to the ego utility asset as the subject of the onboarding process so that the ego utility device is onboarded to an existing group of utility assets. Additionally or alternatively, the ego utility asset may host the onboarding application.

The onboarding application converts data from a power curve and the control system, such as a Supervisory Control and Data Acquisition (SCADA) system, to report on operations of the ego utility asset. For instance, in some examples, the power curve is provided from the manufacturer of the ego utility asset in PDF format. Moreover, the information (e.g., unit types) in the power curve PDF may be different for different manufacturers of utility assets. The software application is configured to convert the power curve into data consumable by the onboarding application, and to convert features in the power curve into customized values that are employable as parameters that can be used along with SCADA system data.

Additionally, in some situations, the onboarding application may not get sufficient data for the ego utility asset from the SCADA system. In these situations, the onboarding application can ping the SCADA system for parameters of a similarly situated utility asset. These parameters of the adjacent utility asset can be used to provide a portion of operating parameters of the ego utility asset. For instance, suppose that the ego utility asset is a wind turbine, and the SCADA system for the ego utility asset needs a windspeed. Additionally, suppose that the ego utility asset has a defective anemometer. In this situation, the onboarding application can ping the SCADA system for a current windspeed of an adjacent (already onboarded) wind turbine. Additionally, the adjacent wind turbine would have the same, or nearly the same windspeed as the ego utility asset. Thus, the windspeed of the adjacent wind turbine can be used by the onboarding application as the current windspeed of the ego utility asset. Moreover, in this same situation, the onboarding application can generate a maintenance work request for installation/correction of an anemometer on the ego utility asset.

Further, the onboarding operations may require compliance with a power purchase agreement (PPA). For instance, the PPA may specify that an hourly power output by the ego utility asset is to be provided to a third party specified in the PPA. In this situation, the onboarding application can receive data characterizing the information needed for the third party and extracts operating data from the SCADA system that is employable to generate the information specified in the PPA (e.g., calculate an hourly power generation of the ego utility asset).

By employing the onboarding application, the onboarding time for utility assets (e.g., the ego utility asset) is reduced from the conventional duration of 140 days to about 4-14 days. By extracting and customizing data from the power curve and/or the SCADA system (e.g., for an adjacent utility asset) data that is conventionally entered manually can be derived automatically, which reduces the time needed for the onboarding.

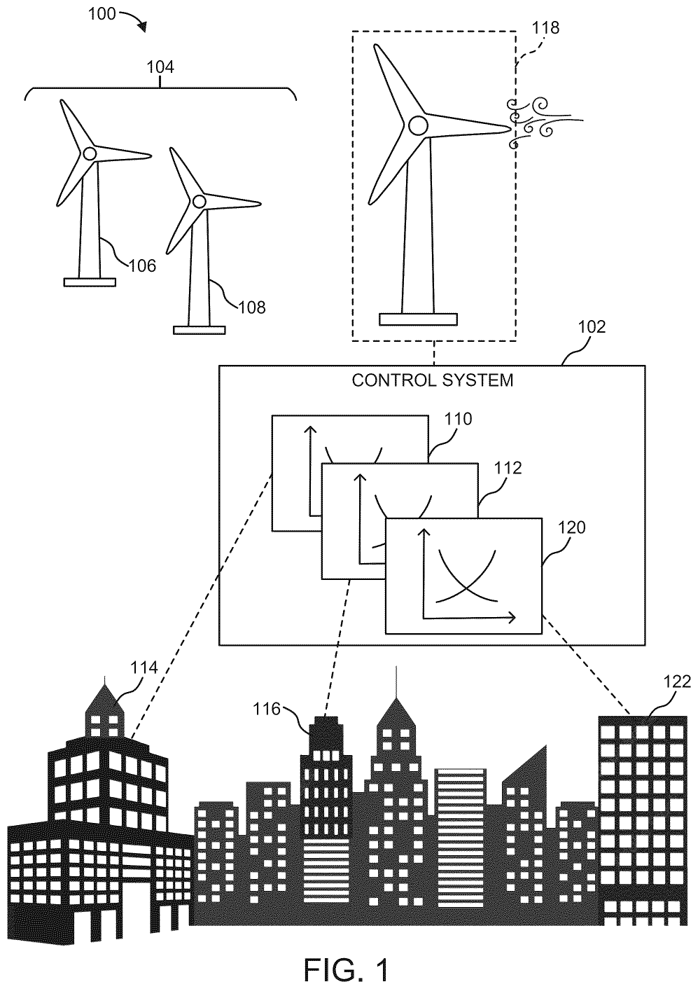

FIG. 1 illustrates a diagram of an example physical environment 100 for a utility asset onboarding system. The utility asset onboarding system includes a control system 102 communicates with a SCADA system that is employed to collect data from N number of proximate utility assets of a farm of utility assets 104, where N is an integer greater than or equal to one. For example, the farm of utility assets 104 includes a first proximate utility asset 106 and a second proximate utility asset 108. In some examples, the plurality of utility assets can have different characteristics, such as being of a different make and/or model, output capacity, size, and orientation. FIG. 1 illustrates one farm of utility assets 104, however, any number of farms of utility assets can be implemented in a similar manner. In some examples, the proximate utility assets 106, 108 are wind turbines, but may be any utility assets including renewable energy utility assets such as solar panels, geothermal turbines, hydropower turbines, etc.

Further, the farm of utility assets 104 is associated with at least one sensor to measure operational data regarding an operational state of the proximate utility assets 106, 108, such as power generation, blade span, airfoil profiles, chord lengths and/or twist of the blades of respective proximate utility assets 106, 108. The plurality of sensors may include, but are not limited to an azimuth sensor, a mode shape and flap (MSF) sensor, a frequency sensor (e.g., to measure vibrations), etc. Additionally or alternatively, the sensors provide environmental data (e.g., temperature, wind speed, incident solar radiation, etc.) to the control system 102 that characterizes the measured ambient conditions of the farm of utility assets 104. In one example, each of the proximate utility assets is equipped with a sensor. As another example, the sensor is logically and/or physically positioned proximal to the farm of utility assets 104 (e.g., upstream). The sensor can be located and operated on an external system, such as a meteorological station (e.g., weather station) proximate (e.g., up to about 20 kilometers) from the farm of utility assets 104.

The control system 102 also receives equipment power curves, including a first power curve 110 corresponding to the first proximate utility asset 106 and/or a second power curve 112 corresponding to the second proximate utility asset 108. A power curve graphs power generation of a proximate utility asset 106, 108 as a function of operational and/or environmental data, collectively referred to as power curve data. In an example in which the first proximate utility asset 106 is a wind turbine, the first power curve 110 graphs the electrical power generated by the first proximate utility asset 106 per a particular parameter of the operational and/or environmental data, such as wind speed at a hub of the first proximate utility asset 106, air density at the farm of utility assets 104, blade angle of the blades of the first proximate utility asset 106, blade length of the blades of the first proximate utility asset 106, etc.

The power curves 110, 112 may be received from different sources in incompatible formats that make it difficult for the control system 102 to incorporate the power curve data from the power curves 110, 112. For example, the first power curve 110 is received from a first source 114, such as a data warehouse, cloud storage, and/or database maintained by an original equipment manufacturer of the first proximate utility asset 106, utility, or governmental entity, among others. Likewise, the second power curve 112 is received from a second source 116, such as a data warehouse, cloud storage, and/or database maintained by an original equipment manufacturer of the second proximate utility asset 108, utility, or governmental entity, among others. In some examples, the first source 114 is different than the second source 116. The different sources 114, 116 may provide the power curves 110, 112 in different forms. The first power curve 110 being received in a different format than the second power curve 112 complicates extracting and converting the power curve data into a form employable by the control system 102. Accordingly, the control system 102 generates a standardized power curve based on the different power curves 110, 112. The standardized power curve defines standards for the power curve data incorporated by the control system 102.

An ego utility asset 118 is a utility asset that is in the process of being onboarded to the farm of utility assets 104. In response to the ego utility asset 118 entering the onboarding process, the control system 102 receives an equipment power curve 120 from an ego source 122. Like the first power curve 110 and the second power curve 112, the equipment power curve 120 includes power curve data. Because the ego utility asset 118 is new to the farm of utility assets 104, the ego utility asset 118 may not have been activated at the farm of utility assets 104 or the ego utility asset 118 may be probationally active in an observational period. Accordingly, the power curve data from the equipment power curve 120 includes a relation between a set of provided parameters and a corresponding array of expected power values to be generated by the ego utility asset 118. The array of expected power values include an amount of power the ego utility asset 118 is expected to produce per a provided parameter of the set of provided parameters. The set of provided parameters includes operational parameters and/or environmental parameters that the ego utility asset 118 could foreseeably encounter.

The control system 102 includes an onboarding application that normalizes the power curve data from the equipment power curve 120 into data employable by the control system 102 based on the standardized power curve. Accordingly, the equipment power curve 120 of the ego utility asset 118 is automatically customized based on standardized data generated from the first power curve 110 and the second power curve 112 of the first proximate utility asset 106 and the second proximate utility asset 108, respectively, which are already active in a generation period for the farm of utility assets 104. In some examples, the standardized data received as a standardized equipment power curve is received from a single source, such as an original equipment manufacturer (OEM) of the ego utility asset 118.

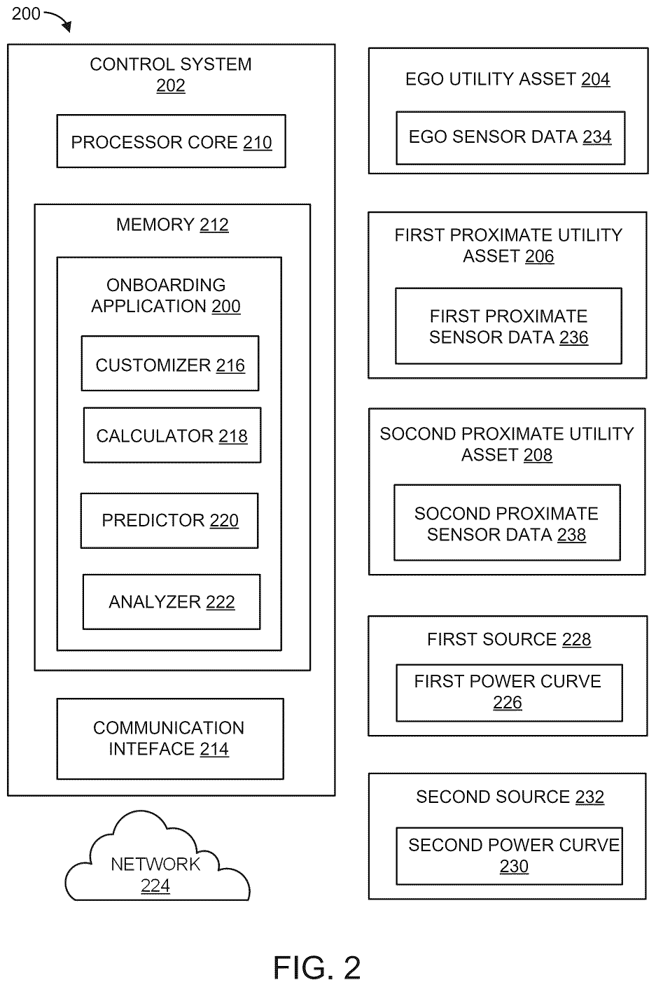

FIG. 2 illustrates an example of an operating environment for a utility asset onboarding application 200. The utility asset onboarding application 200 may represent application software executing on a computing platform of the operating environment having a control system 202 (e.g., the control system 102 of FIG. 1) for onboarding an ego utility asset 204 (e.g., the ego utility asset 118 of FIG. 1) to an existing farm of utility assets including a first proximate utility asset 206 (e.g., the first proximate utility asset 106 of FIG. 1) and a second proximate utility asset 208 (e.g., the second proximate utility asset 108 of FIG. 1).

The control system 202 includes a processor 210, a memory 212, and a communication interface 214, which are operably connected for computer communication. The processor 210 processes signals and performs general computing to execute instructions stored in the memory 212. The instructions cause the processor 210 to execute operations. The processor 210 can be a variety of various processors including multiple single and multicore processors, co-processors, and other multiple single and multicore processor and co-processor architectures.

The memory 212 may store an operating system that controls or allocates resources of the utility asset onboarding application 200. The memory 212 represents a non-transitory machine-readable medium (or other medium), such as RAM, a solid state drive, a hard disk drive or a combination thereof. The utility asset onboarding application 200 includes modules including a customizer 216, a calculator 218, a predictor 220, and an analyzer 222 and stores machine-readable instructions associated with the modules. The utility asset onboarding application 200 could be representative of a single instance of hardware or multiple instances of hardware with applications executing across the multiple of instances (i.e., distributed) of hardware (e.g., computers, routers, memory, processors, or a combination thereof). Alternatively, the utility asset onboarding application 200 could be implemented on a single dedicated server. In various examples, the utility asset onboarding application 200 can include more less of the modules.

The communication interface 214 provides software and hardware to facilitate data input and output between the utility asset onboarding application 200 and data sources, such as the ego utility asset 204, the first proximate utility asset 206, and the second proximate utility asset 208 via a network 224. The network 224 is, for example, a data network, the Internet, a wide area network (WAN) or a local area (LAN) network. The network 224 serves as a communication medium to various remote devices (e.g., databases, web servers, remote servers, application servers, intermediary servers, client machines, other portable devices).

The communication interface 214 may additionally facilitate data input and output between the utility asset onboarding application 200 and sources associated with the utility assets. For example, the customizer 216 may receive a first power curve 226 (e.g., the first power curve 110 of FIG. 1) associated with the first proximate utility asset 206 from the first source 228 (e.g., the first source 114 of FIG. 1) and a second power curve 230 (e.g., the second power curve 112 of FIG. 1) associated with the second proximate utility asset 208 from the second source 232 (e.g., the second source 116 of FIG. 1). The customizer 216 generates a standardized power curve based on the first power curve 226 and the second power curve 230. For example, the customizer 216 extracts the power curve data from the first power curve 226 and the second power curve 230 and converts the power curve data to a common format represented by the standardized curve. Therefore, the standardized power curve transforms power curve data to a standard format that is consistent for the different power curves received from any of the sources.

To generate the standardized power curve, the customizer 216 defines standard parameters including, but not limited to, calculations, formats, data fields, units, languages, and/or character sets, among others. The standard parameters may be based on the power curve data received from different sources. In various examples, the power curve data is extracted from the first power curve 226 and the second power curve 230 and analyzed to define the standard parameters. The customizer 216 generates a standardized curve based on the standard parameters. In particular, the customizer 216 receives power curve data including power generation of a proximate utility asset 206, 208 as a function of operational and/or environmental data (e.g. wind speed, air density, blade angle, incident radiation, etc.). In one example, analysis of the power curves 226, 230, includes the customizer 216 identifying a particular parameter of the operational and/or environmental data common to the first power curve 226 and the second power curve 230.

In response to identifying a particular parameter common to a threshold number of power curves, the customizer 216 defines the particular parameter as a standard parameter. Suppose that the first power curve 226 graphs electrical power generated by the first proximate utility asset 206 per air density measured in the units: kilogram per cubic meter (kg/m³), and the second power curve 230 graphs electrical power generated by the second proximate utility asset 208 per air density measured in the units: pounds per cubic foot (lb./cu ft.). With a threshold number of power curves set to two, the customizer 216 identifies air density as a standard parameter. In some examples, the customizer 216 identifies the calculation of electrical power per the standard parameter, here air density, as a standard calculation because the particular parameter and the calculation are common to the first power curve 226 and the second power curve 230. Accordingly, the standardized curve includes the calculation of electrical power per air density.

For clarity, the examples herein are described with respect to two proximate utility assets 206, 208 corresponding to two power curves 226, 230. However, a farm of utility assets may include any number of utility assets corresponding to any number of power curves. For example, the first proximate utility asset 206 may be associated with five power curves corresponding to power generated per different operational and/or environmental parameters. The second proximate utility asset 208 may be associated with three power curves, for eight power curves in a set of power curves associated with the two proximate utility assets 206, 208. In various examples, determining that a particular parameter of operational and/or environmental data is common to a threshold number of power curves is based on the total number of power curves of the set of power curves. The threshold number of power curves may be a majority of power curves, a predetermined number of power curves, a plurality of power curves, etc. Continuing the example from above in which the total number of power curves in the set of power curves is eight, the threshold may be five or greater power curves thereby defining the majority. The threshold may be two power curves defining a plurality of power curves. In this manner the standardized curve is generated based on the number of power curves in the set of power curves.

In some examples, the customizer 216 generates a set of standardized curves. For example, the set of standardized curves may include standardized curves based on different standard parameters that are not common to each power curve. Suppose that the first power curve 226 graphs electrical power of the first proximate utility asset 206 per air density measured in the units: kilogram per cubic meter (kg/m³), but the second power curve 230 graphs electrical power of the second proximate utility asset 208 per wind speed measured in the units: meters per second (m/s). The customizer 216 identifies air density as a standard parameter and the calculation of electrical power per air density as a standard calculation based on the first power curve 226. The customizer 216 also identifies wind speed as a standard parameter and the calculation of electrical power per wind speed as a standard calculation based on the second power curve 230. Accordingly, the set of standardized curves includes a first standardized curve based on a first standard parameter, for example, the calculation of electrical power per air density, and a second standardized curve based on a second standard parameter, for example, the calculation of electrical power per wind speed.

Additionally or alternatively, the customizer 216 may define standard parameters based on geographic location of a utility asset, operator location, international standards, type of utility asset, etc. In some examples, the customizer 216 transforms the power curve data from the set of power curves to conform to the standardized curve. Suppose the customizer 216 defines units of air density based on the International Standard Atmosphere which uses kg/m³, and the second power curve 230 graphs electrical power of the second proximate utility asset 208 per air density measured in pounds per cubic foot (lb./cu ft.). The customizer 216 may recalculate the second power curve 230 to graph electrical power of the second proximate utility asset 208 per air density measured in kg/m³. Therefore, power curves from the set of power curves of the proximate utility assets 206, 208 may be customized to conform to the standardized curve.

In an onboarding operation, the customizer 216 normalizes incoming power curves for utility assets being onboarded to the farm of utility assets. For example, in response to receiving an equipment power curve (e.g., the equipment power curve 120 of FIG. 1) from an ego utility asset 204 (e.g., the ego utility asset 118 of FIG. 1), the customizer 216 normalizes the equipment power curve based on the standardized power curve to generate a customized power curve for the ego utility asset 204. The customized power curve structures the power curve data of the equipment power curve to conform to the structure of the standardized power curve.

The equipment power curve includes a relation between a set of provided parameters and a corresponding array of expected power values to be generated by the ego utility asset 204. For example, the equipment power curve may include the array of expected power values based on a provided parameter, such as wind speed. The set of provided parameters includes operational parameters and/or environmental parameters that the ego utility asset 118 could foreseeably encounter. Accordingly, the set of provided parameters are values characterizing virtual operational and/or environmental parameters estimated for the ego utility asset 204 rather than operational and/or environmental parameters experienced or measured by the ego utility asset 204.

The customizer 216 extracts power curve data from the equipment power curve and identifies a provided parameter. The customizer 216 determines a standard parameter of the standardized power curve corresponding to the provided parameter. For example, if the provided parameter is wind speed, the customizer 216 may select a standardized curve from the set of standardized curves that is also based on wind speed.

The customizer 216 transforms the extracted power curve data of the equipment power curve to satisfy the selected standardized curve. For example, suppose that the standardized curve graphs electrical power per increasing wind speed in units m/s, and the power curve data of the equipment power curve structures the array of expected power values per decreasing wind speed in knots (kt). Customizing the equipment power curve includes converting the provided parameter, here the wind speed from kts, to customized provided parameters, here the wind speed in m/s, so the units of the customized power curve conform to the units of the standardized power curve. Additionally, customizing the equipment power curve includes sorting the expected power values of the array of expected power values per increasing wind speed in units m/s. The transformation may additionally or alternatively include altering the format of the equipment power curve, identifying data fields in the extracted power curve data, translating languages of the equipment power curve, and/or implementing different character sets, among other transformations.

The customizer 216 transforms the hypothetical power curve data of the equipment power curve to conform to the standardized power curve based on the power curves associated with proximate utility assets 206, 208 that are active on the farm of utility assets in a generation period. The generation period begins when the proximate utility assets 206, 208 successfully complete the onboarding process such that the proximate utility assets 206, 208 are onboarded to the farm of utility assets.

The calculator 218 calculates a calculated power value characterizing an actual amount of power generated by the ego utility asset 204 based on a particular parameter. The particular parameter represents a measurable value for the ego utility asset 204, such as an environmental parameter. The particular parameter is measured at a time value by the ego utility asset 204 or by another utility asset (or other device) associated with and/or proximate to the ego utility asset 204. The time value defines the point in time at which the particular parameter is measured.

An actual power value for the ego utility asset 204 characterizes the actual (measured) amount of power generated by the ego utility asset 204 corresponding to the particular parameter at the time value. For example, during the onboarding operation, the ego utility asset 204 may generate power during an observational period. The calculated power value characterizes an actual power value that denotes the actual amount of power generated by the ego utility asset 204 during the observational period relative to the particular parameter. During the observational period, a number of calculated power values may be calculated for a number of time values to generate a set of actual power values.

In an example in which the ego utility asset 204 is wind turbine, the particular parameter is wind speed and the calculator 218 calculates the calculated power value for the ego utility asset 204 based on the wind speed. The calculator 218 calculates the calculated power value dependent on the particular parameter. For example, the calculated power value, P, may be calculated with Equation 1.

$$P = \frac{1}{2} {C}_{p} ρπ {R}^{3} {V}^{3} \qquad Equation 1$$

wherein:
   Cₚ is the coefficient of performance (efficiency factor, in percent);
   ρ is air density (in kg/m³);
   R is the blade length (in meters) of the blades of the ego utility asset 204; and
   V is the wind speed (in meters per second);

Accordingly, by using Equation 1, with the wind speed, V as the particular parameter, the calculated power value P is calculated to characterize the actual amount of power generated by the ego utility asset 204 during the observational period as function of the particular parameter.

In another example, the actual power value is determined independently of particular parameter and is instead associated with the particular parameter based on the time value. For instance, the actual power value, indicating an amount of power generated by the ego utility asset 204, may be recorded by an electrical meter at given time value, and an anemometer of another device may record the windspeed at the given time value. The calculator 218 calculates the calculated power value by determining the time dependent correspondence between the recorded actual power and recorded wind speed. Thus, the calculated power value is the paring (e.g., correlation) of the actual power value and the particular parameter. In this manner, the calculated power value characterizes the actual amount of power generated by the ego utility asset 204 at a time, t₁, relative to the particular parameter for the time, t₁.

The particular parameter may be identified in the ego sensor data 234 captured by an environmental sensor, such as an anemometer, of the ego utility asset 204. In some examples, the ego sensor data 234 does not include the particular parameter. A sensor that captures the particular parameter as ego sensor data 234 may be damaged, faulty, or missing. The control system 102 may ping other utility assets or data sources to request the particular parameter for a time value. For example, the first proximate utility asset 206 may capture first proximate sensor data 236 from a sensor of the first proximate utility asset 206 and the second proximate utility asset 208 may capture second proximate sensor data 238 from a sensor of the second proximate utility asset 208. The first proximate sensor data 236 and/or the second proximate sensor data 238 may include the particular parameter, for example—wind speed. The calculator 218 may select the first proximate sensor data 236 or the second proximate sensor data 238 to identify the particular parameter based on the proximity of the first proximate utility asset 206 to the ego utility asset 204 as compared to the proximity of the second proximate utility asset 208 to the ego utility asset 204. In particular, the calculator 218 selects the proximity sensor data corresponding to the closer proximate utility asset.

The particular parameter may also be received from a centralized aggregator that receives sensor data from a set of utility assets including the ego utility asset and the proximate utility asset. The centralized aggregator may be a meteorological station (e.g., weather station) in relatively close proximity (e.g., up to about 20 kilometers) from the ego utility asset 204. The centralized aggregator may be a transformer station or substation that is electrically coupled to the ego utility asset 204 or the farm of utility assets and stores or captures sensor data including the particular parameter.

The predictor 220 predicts a predicted power value characterizing a predicted amount of power to be generated by the ego utility asset 204 for the particular parameter based on the customized power curve. The predictor 220 identifies the expected power value for a customized provided parameter that corresponds to the particular parameter. Returning to the example above, suppose the equipment power curve of the ego utility asset 204 is customized such that the customized power curve graphs the array of expected power values per the customized provided parameters: the wind speed in m/s, so the units of the customized power curve conform to the units of the standardized power curve. The predictor 220 determines an expected power value from the array of expected power values that corresponds to the particular parameter.

The analyzer 222 calculates a performance metric for the ego utility asset 204 that characterizes a comparison of the calculated power value and the predicted power value. Thus, the performance metric indicates the performance of the ego utility asset 204 relative to the expected performance. In various examples, the comparison identifies energy loss by determining the difference between the calculated power value and the predicted power value in response to the calculated energy being less than the predicted energy.

Because energy loss may indicate that the ego utility asset has encountered a problem, the performance metric may have a dynamic value when energy loss is identified and have a set value when energy loss is not identified. For example, when the predicted power value is greater than the calculated power value, the greater the difference between the calculated power value and the predicted power value, the lower the performance metric. Conversely, the smaller the difference between the calculated power value and the predicted power value when the predicted power value is greater than the actual energy, the higher the performance metric. Accordingly, the performance metric is dynamic as a function of the difference between the calculated power value and the predicted power value when the predicted power value is greater than the actual energy. However, when the calculated power value is greater than the predicted power value, the performance metric may be a set value that indicates that the ego utility asset is performing better than expected. Thus, the performance metric identifies a degree to which the ego utility asset 204 is not performing as well as expected. Accordingly, an operator can determine a level of disfunction and can diagnose the ego utility asset 204, for example, that the ego utility asset 204 and may benefit from tuning operational parameters or an expedited maintenance schedule or comprehensive maintenance schedule should be selected. The performance metric can also indicate when operation of the ego utility asset 204 is operating normally such that the ego utility asset is functioning as expected.

The controller 202 may utilize the performance metric to determine if the ego utility asset 204 satisfies predetermined standards, such as a power threshold, defined in a PPA. For example, to generate compliance information required by the PPA, the analyzer 222 compares the performance metric to the power threshold. The analyzer 222 determines if the ego utility asset 204 meets predetermined standards based on the comparison. For example, in response to the performance metric satisfying the power threshold, the analyzer 222 generates the compliance information required by the PPA. The analyzer 222 may additionally or alternatively identify other power information as relevant to compliance.

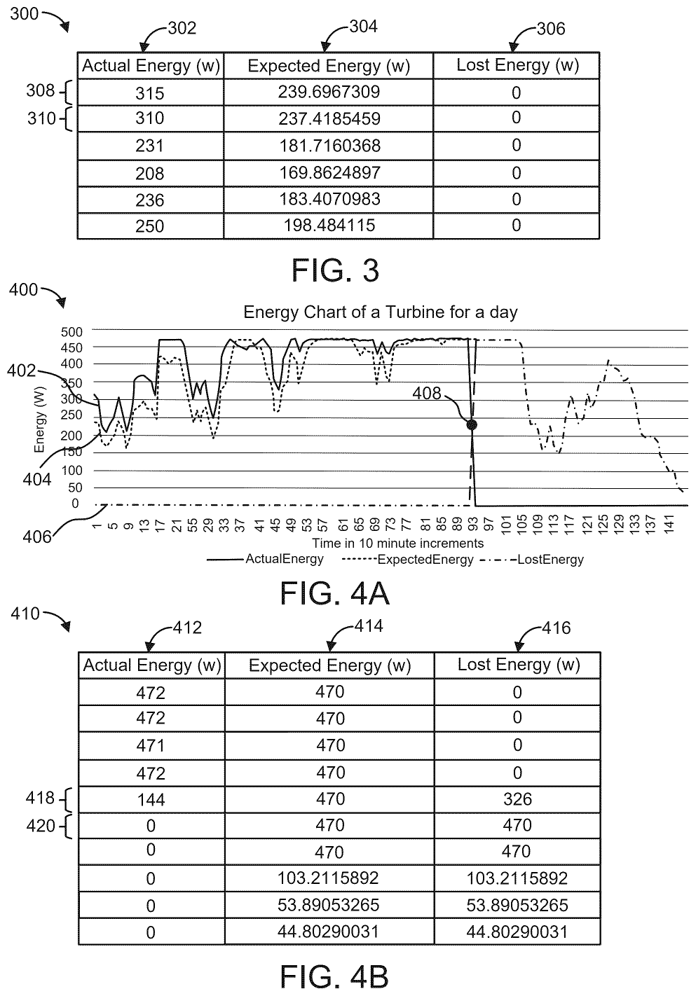

Turning to FIG. 3, an example of a table of energy data for the ego utility asset (e.g., the ego utility asset 118 of FIG. 1, the ego utility asset 204 of FIG. 2) determined by utility asset onboarding system (e.g., the utility asset onboarding application 200) is shown. The calculated power values characterizing the actual amount of power generated by the ego utility asset, calculated by the calculator (e.g., the calculator 218 of FIG. 2), is given in the first column 302 of the table 300 in watts. The predicted power values characterizing a predicted amounts of power generated by the ego utility asset, predicted by the predictor (e.g., the predictor 220 of FIG. 2), are given in the second column 304. The third column 306 illustrates the comparison, calculated by the analyzer (e.g., the analyzer 222 of FIG. 2), of the calculated power values of the first column 302 to the predicted power values of the second column 304 for particular parameters corresponding to the first row 308 and the second row 310.

For example, the first particular parameter of the first row 308 may be a wind speed of 5.8 m/s. The calculated power value in the first column 302 corresponding to the wind speed of 5.8 m/s is 315 watts and the predicted power value in the second column 304 corresponding to the wind speed of 5.8 m/s is about 240 watts. Because the calculated power value is greater than the predicted power value for the first particular parameter, the wind speed of 5.8 m/s, the ego utility asset is not losing energy, as shown in third column 306. Because there is no energy loss, the comparison value of the third column 306 at the first row 308 is zero.

The second particular parameter of the second row 310 may be a wind speed of 5.6 m/s. The calculated power value in the first column 302 corresponding to the second particular parameter, the wind speed of 5.6 m/s, is 301 watts and the predicted power value in the second column 304 corresponding to the wind speed of 5.6 m/s is about 237 watts. Again, the actual power is greater than the predicted power at the wind speed of 5.6 m/s, so the ego utility asset is not losing energy, as shown in the third column 306. Here, the actual power values associated with the calculated power values in the first column 302 are greater than the predicted power values of the second column 304 so the performance metric may be the set value of zero to indicate that there is no energy loss.

Performance metrics may be calculated per value of the predicted parameter, for example, the comparison of the calculated power and predicted power value of the first row 308. Alternatively, the performance metric may be calculated based on a set of comparisons of the calculated power values and predicted power values of a plurality of respective particular parameters. As one example, the performance metric may be the set value when a predetermined number of consecutive comparisons is zero or when a threshold number of comparisons of a set of comparisons is equal to zero. Alternatively, the performance metric may be an average of comparisons or a trend line of comparisons when the comparison is a value greater than zero.

FIG. 4A illustrates an example energy chart 400 of an ego utility asset including actual energy, expected energy, and lost energy in watts per ten-minute increments. When the calculated power values 402 are greater than the predicted power values 404, the comparison value 406 is zero. After a crossover point 408, the calculated power values 402 are less than the predicted power values 404, and the comparison value 406 is greater than zero and increases the proportionally to the difference given by the predicted power value 404 subtracted from the calculated power value 402 at a given time.

The crossover point 408 is also illustrated in the table 410 of FIG. 4B corresponding to the example energy chart 400 of FIG. 4A. The actual amount of power generated by the ego utility asset is given by the calculated power values in the first column 412 in watts. The predicted power values, characterizing a predicted amounts of power generated by the ego utility asset, are given in the second column 414 in watts. The third column 416 illustrates the comparison of the calculated power values of the first column 412 to the predicted power values of the second column 414 for particular parameters. For example, the crossover point 408, shown in FIG. 4A, corresponds to pre-crossover row 418 and a post crossover row 420 in the table 410. In the pre-crossover row 418, the calculated power value of the first column 412 is greater than the predicted power value of the second column 414. Accordingly, the energy loss is zero, as shown in the third column 416. After the crossover point 408, in the post crossover row 420, the calculated power value of the first column 412 is less than the predicted power value of the second column 414. Accordingly, the energy loss is 326 watts. Because the energy loss increases, the performance metric decreases from a set value, zero, to a dynamic energy loss value of 326 watts.

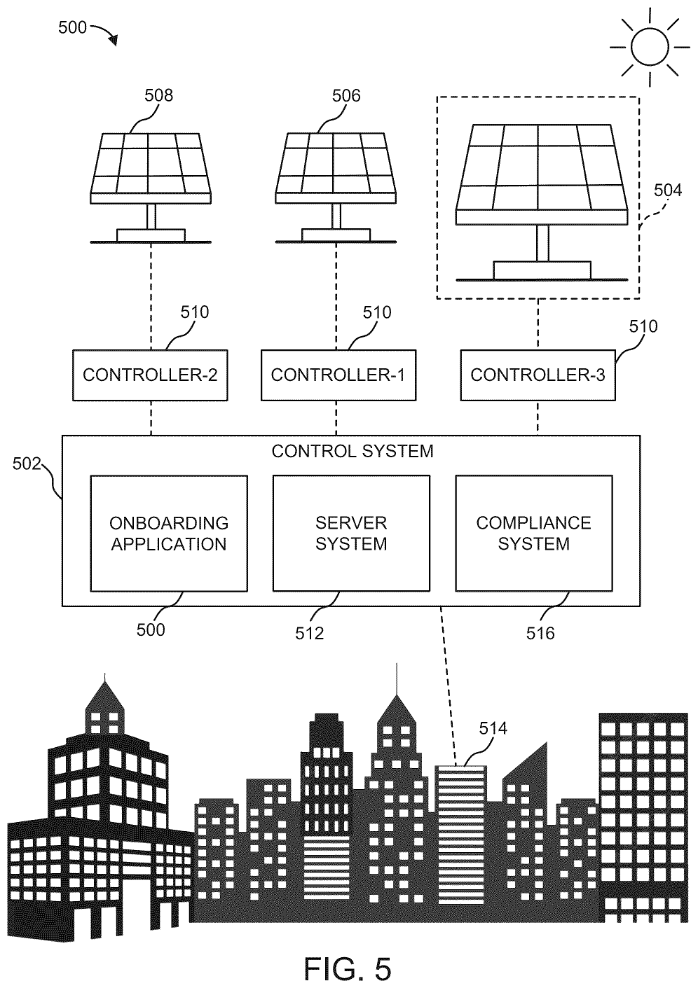

The utility asset onboarding application can be used for various renewable energy utility assets for numerous purposes. For example, FIG. 5 illustrates a diagram of another example physical environment for a utility asset onboarding application 500. (e.g., the utility application 200 of FIG. 2) hosted by a control system 502 (e.g., the control system 202 of FIG. 2). The utility asset onboarding application 500 onboards an ego utility asset 504 (e.g., the ego utility asset 118 of FIG. 1, the ego utility asset 204 of FIG. 2), here a solar panel, to an existing array of utility assets. The array of utility assets includes a first proximate utility asset 506 (e.g., the first proximate utility asset 106 of FIG. 1, the first proximate utility asset 206 of FIG. 2) and a second proximate utility asset 508 (e.g., the second proximate utility asset 108 of FIG. 1, the second proximate utility asset 208 of FIG. 2), here, solar panels.

In a similar manner as described above, the onboarding application converts data from a power curve into data employable by the control system 502. For example, each utility asset may include a controller 510, for example, as a programmable logic controller (PLC). A server system 512 of the control system 502 can provide commands to each of the N number of utility assets, such as the first proximate utility asset 506 and the second proximate utility asset 508, of the array of utility assets as well as the ego utility asset 504 to control operations of the utility assets. In response, the controller 510 updates the operating parameters of the corresponding utility asset.

For instance, the utility asset onboarding application 500 may cause the server system 512 to send a command to the controller-1 510 of the first proximate utility asset 506 to activate a sensor and measure a particular parameter, such as parameter is incident radiance on the solar panel. Therefore, even if the equipment power curve (e.g., the equipment power curve 120) associated with the ego utility asset 504 does not include sufficient information, the utility asset onboarding application 500 can ping an adjacent utility asset, such as the first proximate utility asset 506 that is active in a generation period for the particular parameter. Accordingly, the utility asset onboarding application 500 can take advantage of an adjacent utility asset that would have the same, or approximately the same, particular parameter. As described above, the utility asset onboarding application 500 uses the particular parameter to convert the power curve into data consumable by the onboarding application, and to convert features in the power curve into customized values that are employable as parameters. By extracting and customizing data from the power curve and/or data that is conventionally entered manually in the control system 502, the parameters can be derived automatically, which reduces the time needed for the onboarding.

Additionally, the utility asset onboarding application 500 determines a performance metric that characterizes the performance of the ego utility asset, for example, as a function of energy loss. Based on the performance metric, the utility asset onboarding application 500 may generate a remedial action, such as generating a maintenance work request for installation of a sensor, for example a light sensor, on the ego utility asset 504.

Further, the onboarding operations may require compliance with a PPA that specifies compliance information to be provided to a third party 514 (e.g. a customer) specified in the PPA. For instance, the PPA may specify that the compliance information includes an hourly power output by the ego utility asset 504 is to be provided to the third party 514. In this situation, the utility asset onboarding application 500 extracts the data needed to calculate the compliance information. For example, a compliance system 516 system may request operating data from the utility asset onboarding application 500. The utility asset onboarding application 500 extracts the requested operating data, for example the calculated power value, and provides the requested operating data to the compliance system 516. The compliance system 516 generates the compliance information specified in the PPA (e.g., calculate an hourly power generation of the new utility asset). The compliance system 516 packages the compliance information and provides the packaged compliance information to the third party 514.

In some examples, in response to the compliance system 516 identifying compliance information from the PPA, the utility asset onboarding application 500 determines that the ego utility asset 504 is in compliance with the PPA based on the performance metric. For example, the compliance information defines a power threshold. The analyzer (e.g., the analyzer 222 of FIG. 2) of the utility asset onboarding application 500 compares the performance metric to the power threshold. In response to the performance metric satisfying the power threshold, the ego utility asset is deemed to be in compliance. The analyzer further identifies power information to be provided to the third party 514.

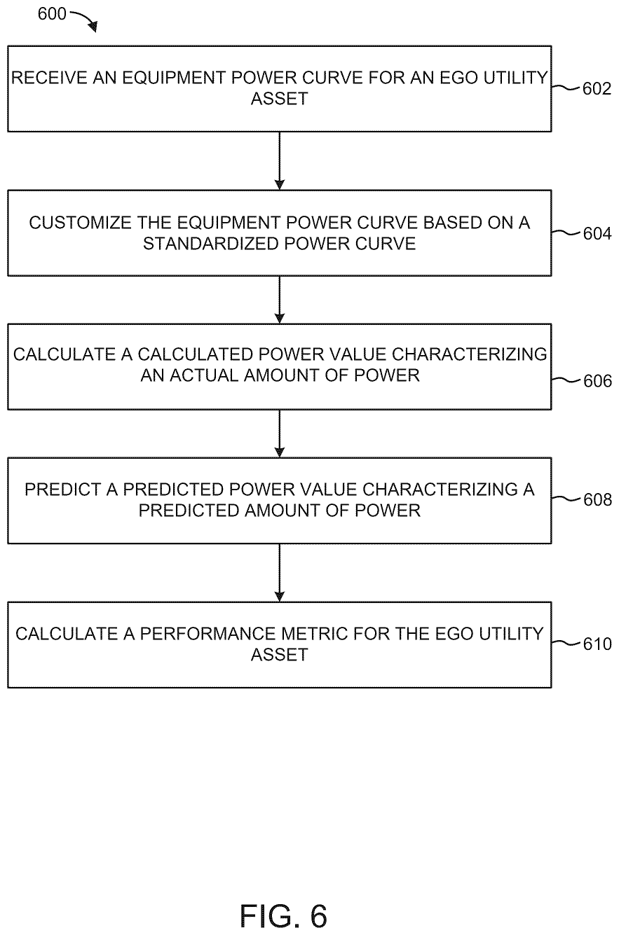

FIG. 6 illustrates a flowchart of an example method for onboarding a utility asset. FIG. 6 will also be described with reference to FIGS. 1-5. For simplicity, the method 600 will be described as a sequence of blocks, but it is understood that the elements of the method 600 can be organized into different architectures, elements, stages, and/or processes.

At block 602, the method 600 includes receiving an equipment power curve (e.g., the equipment power curve 120) for an ego utility asset (e.g., the ego utility asset 118 of FIG. 1, the ego utility asset 204 of FIG. 2, the ego utility asset 504 of FIG. 5) to be onboarded in a farm of utility assets. The equipment power curve including a relation between a set of provided operational parameters and a corresponding array of expected power values generated by the ego utility asset.

At block 604, the method 600 includes customizing the equipment power curve based on a standardized power curve to generate a customized power curve. The standardized power curve is based on a first power curve (e.g., the first power curve 110 of FIG. 1) from a first source (e.g., the first source 114 of FIG. 1, the first source 228 of FIG. 2) and a second power curve (e.g., the second power curve 112 of FIG. 1) from a second source (e.g., the second source 116 of FIG. 1, the second source 232 of FIG. 2) different than the first source. In some examples, the standardized curve is received from a single source, such an OEM. The customizing may include generating a custom equipment power curve based on the standardized power curve of the OEM given environmental and other contributing parameters of the ego utility asset.

At block 606, the method 600 includes calculating a calculated power value characterizing an actual amount of power generated by the ego utility asset based on a particular parameter.

At block 608, the method 600 includes predicting a predicted power value characterizing a predicted amount of power to be generated by the ego utility asset for the particular parameter based on the customized power curve. Accordingly, the power value characterizing a predicted amount of power to be generated by the ego utility asset is predicted for the particular parameter based on the custom power curve.

At block 610, the method 600 includes calculating a performance metric for the ego utility asset. The performance metric characterizes a comparison of the calculated power value and the predicted power value.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

A “value” as used herein may include, but is not limited to, a numerical or other kind of value or level such as a percentage, a non-numerical value, a discrete state, a discrete value, a continuous value, among others. The term “value of X” or “level of X” as used throughout this description and in the claims refers to any numerical or other kind of value for distinguishing between two or more states of X. For example, in some cases, the value of X may be given as a percentage between 0% and 100%. In other cases, the value of X could be a value in the range between 1 and 10. In still other cases, the value of X may not be a numerical value, but could be associated with a given discrete state, such as “not X”, “slightly x”, “x”, “very x” and “extremely x”.

In this description, unless otherwise stated, “about,” “approximately” or “substantially” preceding a parameter means being within +/−10 percent of that parameter. Modifications are possible in the described embodiments, and other embodiments are possible, within the scope of the claims.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A non-transitory machine-readable medium having machine-readable instructions for an asset onboarding system causing a processor to execute operations, the operations comprising:
receiving a standardized equipment power curve for an ego utility asset to be onboarded in a farm of utility assets, the standardized equipment power curve including a relation between a set of provided operational parameters and a corresponding array of expected power values generated by the ego utility asset;
customizing the equipment power curve based on the standardized power curve to generate a customized power curve;
calculating a calculated power value characterizing an actual amount of power generated by the ego utility asset based on a particular parameter;
predicting a predicted power value characterizing a predicted amount of power to be generated by the ego utility asset for the particular parameter based on the customized power curve; and
calculating a performance metric for the ego utility asset, wherein the performance metric characterizes a comparison of the calculated power value and the predicted power value.

2. The non-transitory machine-readable medium of claim 1, wherein the operations further comprise:
identifying an energy loss of the ego utility asset in response to the actual amount of power being less than the predicted amount of power.

3. The non-transitory machine-readable medium of claim 1, wherein the particular parameter is for a proximate utility asset, and the calculated power value is an estimation for the ego utility asset based on proximity to the proximate utility asset.

4. The non-transitory machine-readable medium of claim 3, wherein the particular parameter is received from a centralized aggregator that receives data from a set of utility assets including the ego utility asset and the proximate utility asset.

5. The non-transitory machine-readable medium of claim 1, wherein the particular parameter is received from an environmental sensor of the ego utility asset.

6. The non-transitory machine-readable medium of claim 1, wherein the operations further comprise:
determining that the ego utility asset is in compliance with a power purchase agreement (PPA) based on the performance metric relative to a power threshold defined in the PPA; and
identifying power information to be provided to a customer based on the PPA.

7. The non-transitory machine-readable medium of claim 1, wherein the ego utility asset is a wind turbine, and the particular parameter is a windspeed at a hub of the wind turbine.

8. The non-transitory machine-readable medium of claim 1, wherein the ego utility asset is a wind turbine the particular parameter is a set of particular parameters that includes a windspeed and air density for the wind turbine.

9. The non-transitory machine-readable medium of claim 1, wherein the ego utility asset is a wind turbine the particular parameter is a set of particular parameters that includes a windspeed and a blade angle of the wind turbine.

10. The non-transitory machine-readable medium of claim 1, wherein the ego utility asset is a solar panel, and the particular parameter is incident radiance on the solar panel.

11. An asset onboarding system comprising:
a memory for storing machine-readable instructions; and
a processor core for accessing the machine-readable instructions and executing the machine-readable instructions as operations, the operations comprising:
receiving an equipment power curve for an ego utility asset to be onboarded in a farm of utility assets, the equipment power curve including a relation between a set of provided operational parameters and a corresponding array of expected power values generated by the ego utility asset;
customizing the equipment power curve based on a standardized power curve to generate a customized power curve, wherein the standardized power curve is based on a first power curve from a first source and a second power curve from a second source different than the first source;
calculating a calculated power value characterizing an actual amount of power generated by the ego utility asset based on a particular parameter;
predicting a predicted power value characterizing a predicted amount of power to be generated by the ego utility asset for the particular parameter based on the customized power curve; and
calculating a performance metric for the ego utility asset, wherein the performance metric characterizes a comparison of the calculated power value and the predicted power value.

12. The asset onboarding system of claim 11, wherein the operations further comprise:
identifying an energy loss of the ego utility asset in response to the actual amount of power being less than the predicted amount of power.

13. The asset onboarding system of claim 11, wherein the particular parameter is for a proximate utility asset, and the calculated power value is an estimation for the ego utility asset based on proximity to the proximate utility asset.

14. The asset onboarding system of claim 13, wherein the particular parameter is received from a centralized aggregator that receives data from a set of utility assets including the ego utility asset and the proximate utility asset.

15. The asset onboarding system of claim 11, wherein the ego utility asset is a wind turbine, and the particular parameter is a windspeed at a hub of the wind turbine.

16. The asset onboarding system of claim 11, wherein the ego utility asset is a solar panel, and the particular parameter is incident radiance on the solar panel.

17. An asset onboarding method comprising:
receiving an equipment power curve for an ego utility asset to be onboarded in a farm of utility assets, the equipment power curve including a relation between a set of provided operational parameters and a corresponding array of expected power values generated by the ego utility asset;
customizing the equipment power curve based on a standardized power curve to generate a customized power curve, wherein the standardized power curve is based on a first power curve from a first source and a second power curve from a second source different than the first source;
calculating a calculated power value characterizing an actual amount of power generated by the ego utility asset based on a particular parameter;
predicting a predicted power value characterizing a predicted amount of power to be generated by the ego utility asset for the particular parameter based on the customized power curve; and
calculating a performance metric for the ego utility asset, wherein the performance metric characterizes a comparison of the calculated power value and the predicted power value.

18. The asset onboarding method of claim 17, further comprising:
identifying an energy loss of the ego utility asset in response to the actual amount of power being less than the predicted amount of power.

19. The asset onboarding method of claim 17, wherein the ego utility asset is a wind turbine, and the particular parameter is a windspeed at a hub of the wind turbine.

20. The asset onboarding method of claim 17, wherein the ego utility asset is a solar panel, and the particular parameter is incident radiance on the solar panel.
